(19) United States
(12) Patent Application Publication
(10) Pub. No.: US 2025/0189793 A1
(43) Pub. Date: Jun. 12, 2025

(54) EYEWEAR FOR DISPLAYING LYRICS IN A KARAOKE SYSTEM

(71) Applicant: James Grayheck, Chicago, IL (US)

(72) Inventor: James Grayheck, Chicago, IL (US)

(21) Appl. No.: 18/530,480

(22) Filed: Dec. 6, 2023

(51) Int. Cl. G02B 27/01; G02C 11/00; G10H 1/36

(52) U.S. Cl. CPC G02B 27/0172; G02C 11/10; G10H 1/361; G02B 2027/014; G02B 2027/0141; G02B 2027/0178; G10H 2210/005; G10H 2220/011

(57) ABSTRACT

A karaoke system for displaying lyrics of a song on eyewear worn by a user includes an eyewear device with a frame configured for being worn on a head of a user, an optical element mounted to the frame, and a heads-up display configured to present the lyrics of the song on the optical element. Lyrics may be displayed on the optical element via the heads-up display to facilitate the user being able to read the lyrics while looking at an audience. A microphone may be mounted to the frame to record the user singing while freeing the user from holding another microphone.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to karaoke systems and more particularly pertains to a new karaoke system for displaying lyrics of a song on eyewear worn by a user.

### (2) Description of Related Art Including Information Disclosed Under 37 CFR 1.97 and 1.98

The prior art relates to various heads-up displays for viewing information on glasses worn by a user. However, the prior art fails to disclose a heads-up device which is used to display lyrics to a song while the song is playing on a remote speaker to facilitate the user in reading the lyrics and singing the song while viewing an audience.

### BRIEF SUMMARY OF THE INVENTION

An embodiment of the disclosure meets the needs presented above by generally comprising an eyewear device with a frame configured for being worn on a head of a user, an optical element mounted to the frame, and a heads-up display configured to present the lyrics of the song on the optical element. The optical element comprises a transparent material and is positioned on the frame such that the optical element is positioned in a field of view of the user when the frame is worn by the user. A processor is operatively coupled to the heads-up display and is configured to cause the heads-up display to present the lyrics of the song in sync with the song being played.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a kit view of a karaoke system according to an embodiment of the disclosure.

FIG. 2 is a front view of an eyewear device of an embodiment of the disclosure.

FIG. 3 is a side view of an eyewear device of an embodiment of the disclosure.

FIG. 4 is a top view of an eyewear device of an embodiment of the disclosure.

FIG. 5 is a cross-section view of an eyewear device of an embodiment of the disclosure taken from Arrows 5-5 in FIG. 4.

FIG. 6 is a cross-section view of an eyewear device of an embodiment of the disclosure taken from Arrows 6-6 in FIG. 4.

FIG. 7 is a rear view of an eyewear device of an embodiment of the disclosure.

FIG. 8 is an in-use view of an embodiment of the disclosure.

FIG. 9 is a block diagram of an embodiment of the disclosure.

### DETAILED DESCRIPTION OF THE INVENTION

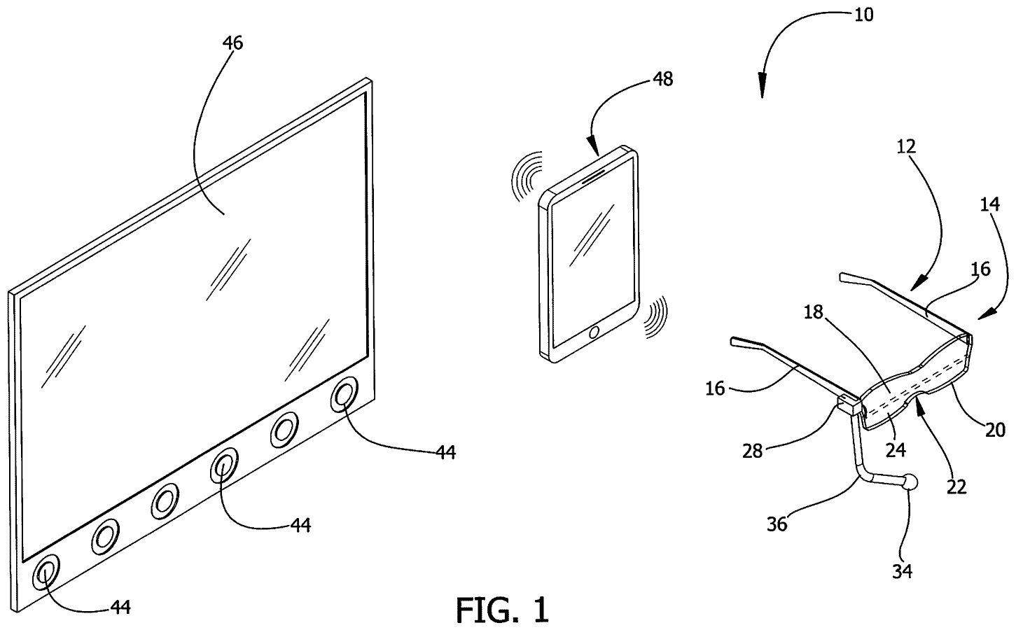

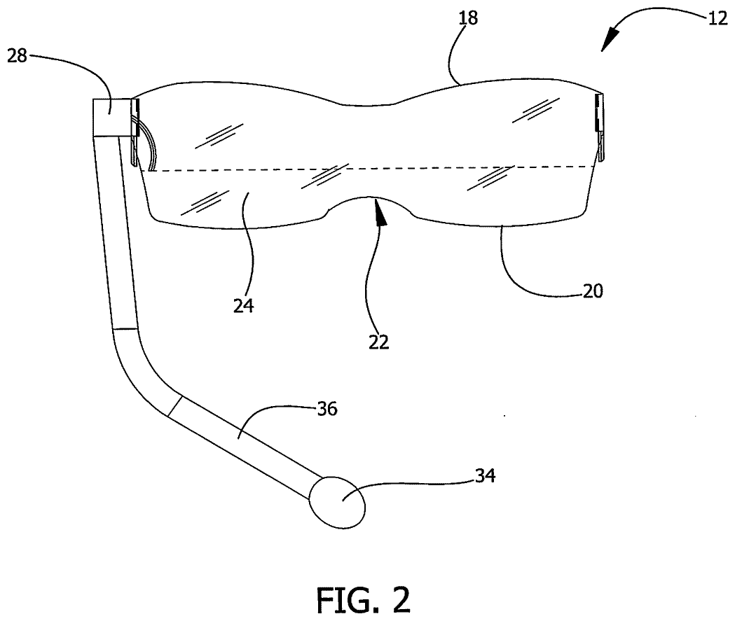

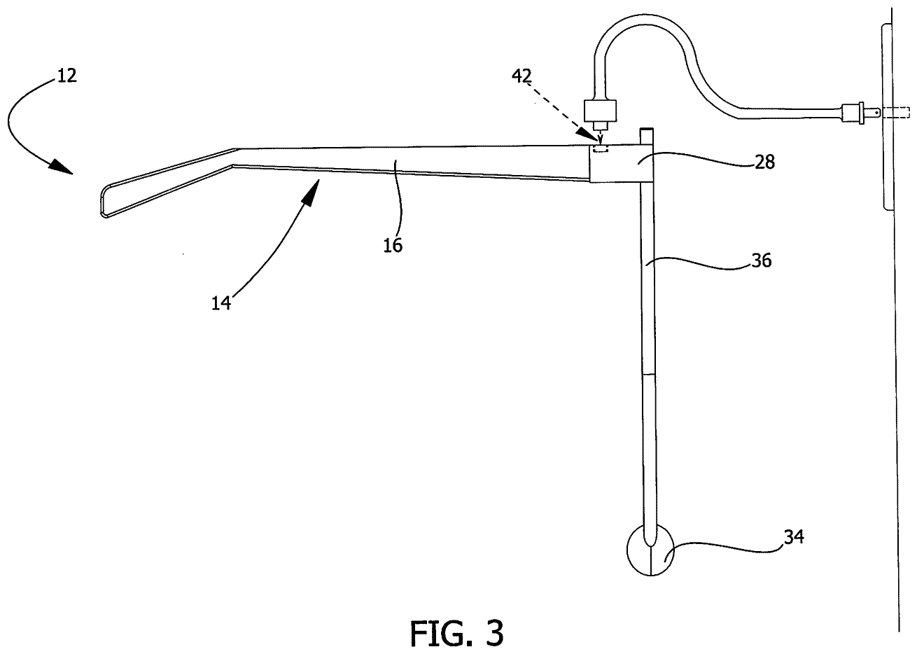

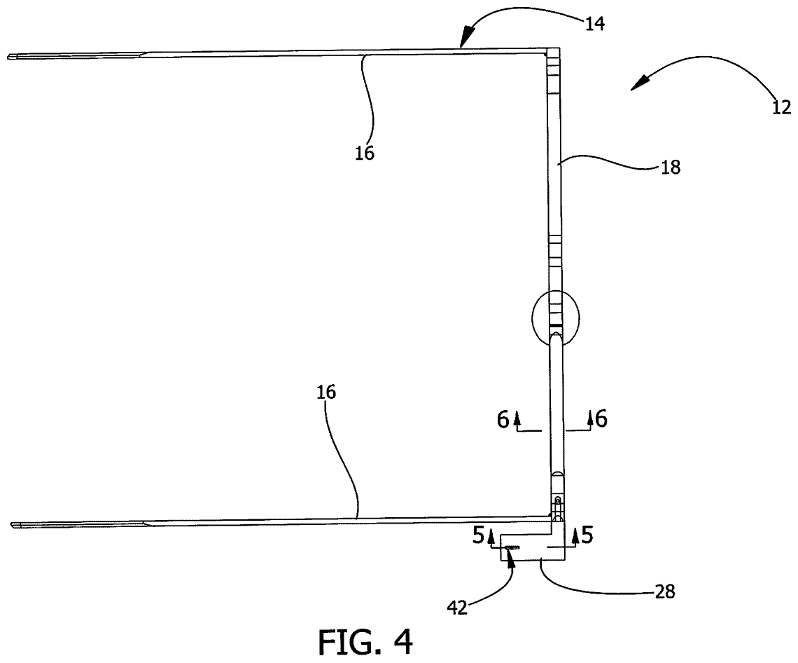

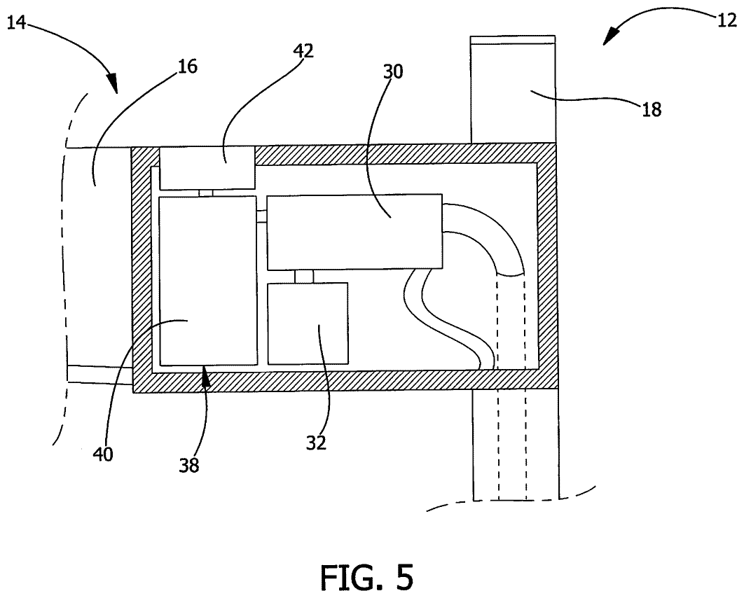

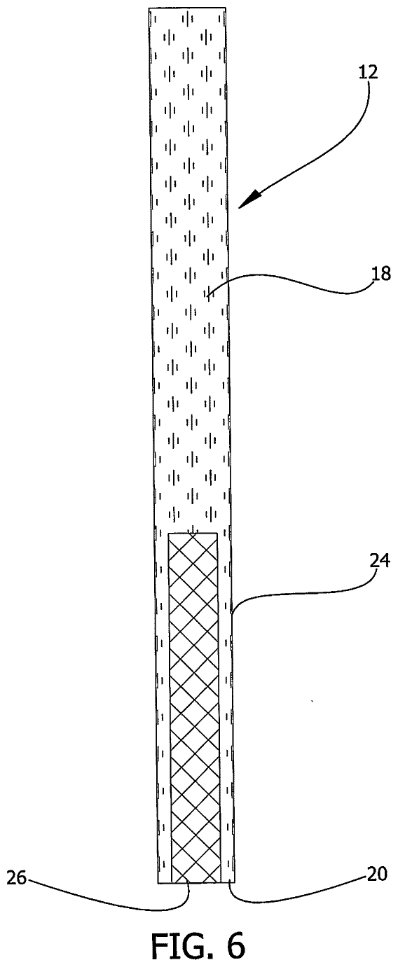

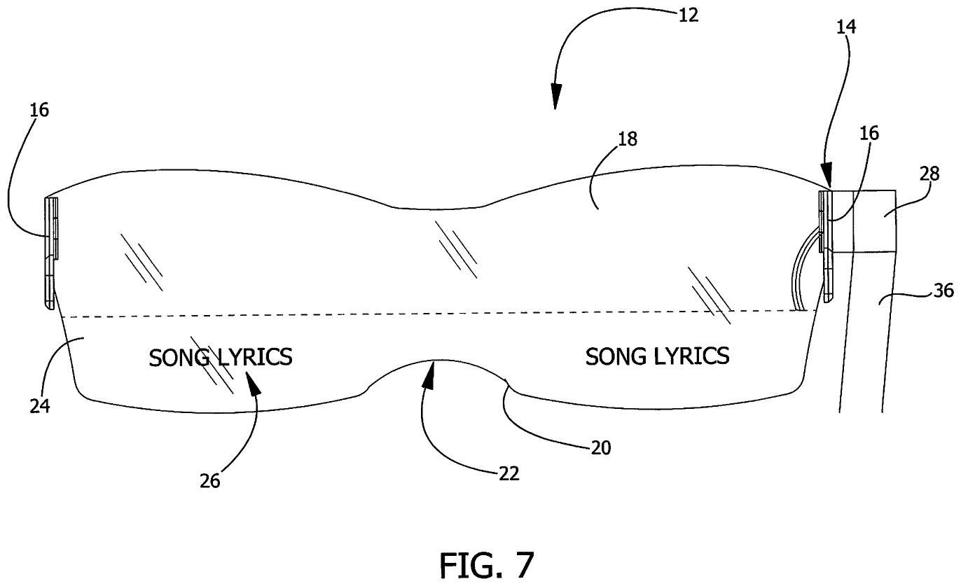

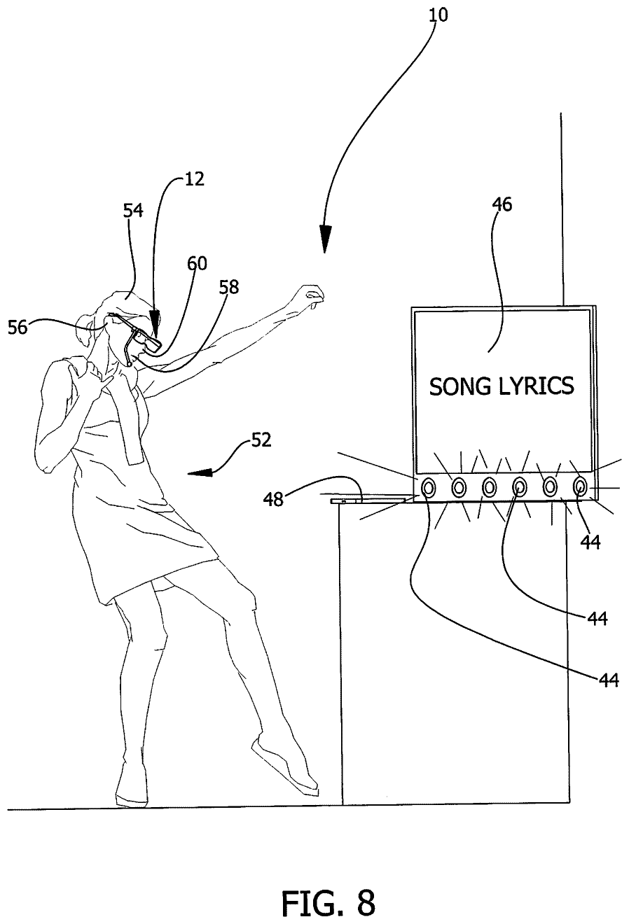

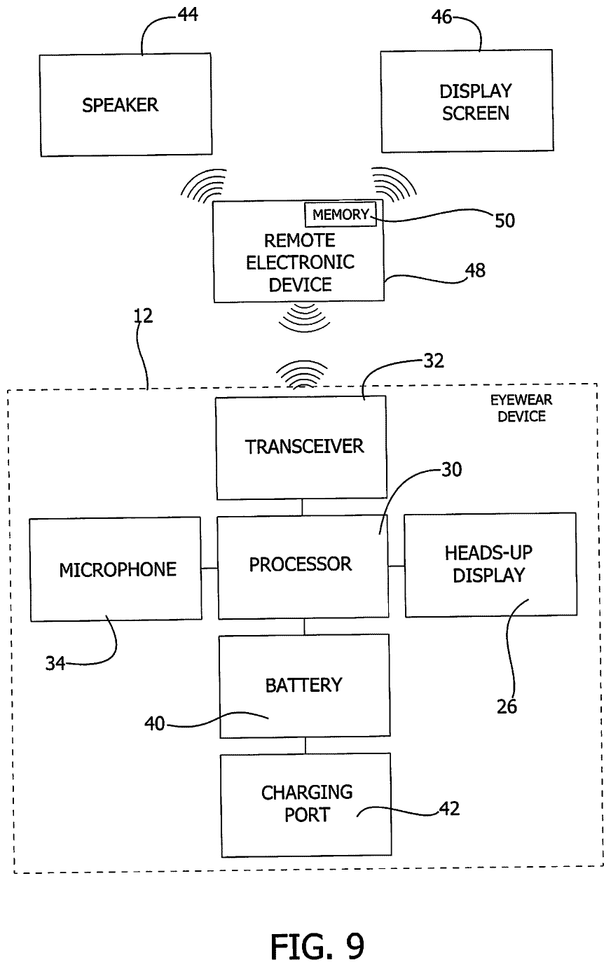

With reference now to the drawings, and in particular to FIGS. 1 through 9 thereof, a new karaoke system embodying the principles and concepts of an embodiment of the disclosure and generally designated by the reference numeral 10 will be described.

As best illustrated in FIGS. 1 through 9, the karaoke system 10 generally comprises an eyewear device 12 with a frame 14, an optical element 18, and a heads-up display 26. The frame 14 is configured for being worn on a head 54 of a user 52 and comprises a pair of temples 16 configured for extending over a pair of ears 56 of the user 52. The optical element 18 is mounted to the frame 14. The optical element 18 is coupled to and extends between the temples 16 so that the optical element 18 is positioned in a field of view of the user 52 when the frame 14 is worn by the user 52. The optical element 18 has a notch 22 on a bottom edge 20 of the optical element 18 for accommodating a nose 60 of the user 52, and the optical element 18 rests on the nose 60 when the frame 14 is worn. In some embodiments, the frame 14 may include a mounting element which is coupled to and extends between the temples 16, and which attaches to the optical element 18. The mounting element may define apertures in which the optical element 18 sits. The frame 14 may also have a nosepiece to rest the frame 14 on the nose 60 of the user 52. In other embodiments, the frame 14 comprises a helmet, a headband, or the like to secure the optical element 18 in view of the user 52. The optical element 18 may be one of a pair of optical elements 18, and the optical elements 18 may be shaped to alter the vision of the user 52 as in prescription lenses.

The heads-up display 26 is configured to present the lyrics of the song on the optical element 18. The heads-up display 26 is embedded in the optical element 18 but may comprise a projector spaced from the optical element 18 which projects the lyrics on the optical element 18. The heads-up display 26 may also include any other suitable display for presenting the lyrics on the optical element 18. The heads-up display 26 depicted in the figures is positioned in a lower portion 24 of the optical element 18 to avoid obscuring the user's 52 vision.

An electronics housing 28 is mounted to the frame 14 and is positioned on one of the pair of temples 16 adjacent to the optical element 18. A processor 30 is mounted in the electronics housing 28 and is operatively coupled to the heads-up display 26. A transceiver 32 is mounted in the electronics housing 28 and is operably coupled to the processor 30. A microphone 34 is operably coupled to the processor 30. A support arm 36 is coupled to and extends between the frame 14 and the microphone 34. The support arm 36 couples the microphone 34 to the frame 14 and is configured to position the microphone 34 adjacent a mouth 58 of the user 52 when the frame 14 is worn by the user 52. The support arm 36 comprises an adjustably bendable material such that a position of the microphone 34 with respect to the frame 14 is adjustable but may comprise pivots, telescopic members, or the like to adjust the position of the microphone 34.

A power supply 38 is mounted in the electronics housing 28 and is electrically coupled to the processor 30. The power supply 38 comprises a battery 40 but may comprise a capacitor or other suitable power storage. The power supply 38 may also be electrically coupled to the heads-up display 26, the transceiver 32, and the microphone 34, either directly or via the processor 30. A charging port 42 is mounted to the electronics housing 28 and is electrically coupled to the power supply 38. The charging port 42 is configured to charge the power supply 38 via an external power source. The power supply 38 may also be removable and replaceable.

A speaker 44 and a display screen 46 are provided which are remote from the eyewear device 12. The speaker 44 and the display screen 46 are attached to each other but may be separate. A remote electronic device 48 is remote from the eyewear device 12, the speaker 44, and the display screen 46, and is communicatively coupled to each of the eyewear device 12, the speaker 44, and the display screen 46. The remote electronic device 48 has a memory 50 with instructions stored therein. The remote electronic device 48 may be a smartphone, a desktop computer, a laptop computer, a tablet, or the like. In some embodiments, the remote electronic device 48 may be attached to the speaker 44 and the display screen 46.

The instructions are executable by the remote electronic device 48 to cause the speaker 44 to play a song, cause both the heads-up display 26 of the eyewear device 12 and the display screen 46 to present lyrics to the song in sync with the speaker 44 playing the song, cause the microphone 34 of the eyewear device 12 to record audio, and cause the speaker 44 to play the audio recorded by the microphone 34 as the speaker 44 plays the song. Each word of the lyrics does not need to be simultaneously presented as the word is played in the song by the speaker 44 for the lyrics to be considered in sync with the song. For example, words may be presented individually momentarily before the words are played on the speaker 44, or a phrase may be presented at once momentarily before the phrase is played on the speaker 44. Any suitable timing may be used. The remote electronic apparatus may have storage for a plurality of songs or access to the plurality of songs via a streaming service or the like. Any of the plurality of songs may be selectable to be played on the speaker 44 and to have the lyrics for the song presented via the display screen 46 and the eyewear device 12.

In use, the user 52 wears the eyewear device 12 on the user's 52 head 54. The song is played via the speaker 44, and the lyrics are presented on the optical element 18 of the eyewear device 12 and the display screen 46. The user 52 sings the lyrics of the song, which is recorded by the microphone 34 and played by the speaker 44 simultaneously with the song.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An eyewear device for displaying lyrics to a song while the song is being played, the device comprising:
a frame configured for being worn on a head of a user;
an optical element mounted to the frame, the optical element being positioned on the frame such that the optical element is positioned in a field of view of the user when the frame is worn by the user, the optical element comprising a transparent material;
a heads-up display configured to present the lyrics of the song on the optical element; and
a processor operatively coupled to the heads-up display, the processor being configured to cause the heads-up display to present the lyrics of the song in sync with the song being played.

2. The device of claim 1, wherein:
the frame comprises a pair of temples configured for extending over a pair of ears of the user; and
the optical element being coupled to and extends between the pair of temples.

3. The device of claim 2, wherein the optical element defines a notch on a bottom edge of the optical element for accommodating a nose of the user, the optical element being configured to rest on the nose.

4. The device of claim 1, wherein the heads-up display is embedded in the optical element.

5. The device of claim 4, wherein the heads-up display is positioned in a lower portion of the optical element.

6. The device of claim 1, further comprising a transceiver operably coupled to the processor, the processor being configured to wirelessly receive instructions from a remote electronic device via the transceiver.

7. The device of claim 6, further comprising a microphone operably coupled to the processor, the processor being configured to transmit audio recorded by the microphone to a remote speaker which plays the song and the transmitted audio simultaneously.

8. The device of claim 7, further comprising a support arm coupled to and extending between the frame and the microphone, the support arm coupling the microphone to the frame, the support arm being configured to position the microphone adjacent to a mouth of the user when the frame is worn by the user.

9. The device of claim 8, wherein the support arm comprises an adjustably bendable material such that a position of the microphone with respect to the frame is adjustable.

10. The device of claim 1, further comprising a power supply mounted in the electronics housing and electrically coupled to the processor.

11. The device of claim 10, wherein the power supply comprises a battery.

12. The device of claim 10, further comprising a charging port mounted to the electronics housing and electrically coupled to the power supply, the charging port being configured to charge the power supply via an external power source.

13. An eyewear device for displaying lyrics to a song while the song is being played, the device comprising:
a frame configured for being worn on a head of a user, the frame comprising a pair of temples configured for extending over a pair of ears of the user;
an optical element mounted to the frame, the optical element being positioned on the frame such that the optical element is positioned in a field of view of the user when the frame is worn by the user, the optical element comprising a transparent material, the optical element being coupled to and extending between the pair of temples, the optical element defining a notch on a bottom edge of the optical element for accommodating a nose of the user, the optical element being configured to rest on the nose;
a heads-up display configured to present the lyrics of the song on the optical element, the heads-up display being embedded in the optical element, the heads-up display being positioned in a lower portion of the optical element;
an electronics housing being mounted to the frame, the electronics housing being positioned on one of the pair of temples adjacent to the optical element;
a processor mounted in the electronics housing and operatively coupled to the heads-up display;
a transceiver mounted in the electronics housing and operably coupled to the processor, the processor being configured to wirelessly receive instructions from a remote electronic device via the transceiver;
a microphone operably coupled to the processor, the processor being configured to transmit audio recorded by the microphone to a remote speaker which plays the song and the transmitted audio simultaneously;
a support arm coupled to and extending between the frame and the microphone, the support arm coupling the microphone to the frame, the support arm being configured to position the microphone adjacent a mouth of the user when the frame is worn by the user, the support arm comprising an adjustably bendable material such that a position of the microphone with respect to the frame is adjustable;
a power supply mounted in the electronics housing and electrically coupled to the processor, the power supply comprising a battery; and
a charging port mounted to the electronics housing and electrically coupled to the power supply, the charging port being configured to charge the power supply via an external power source.

14. A karaoke system comprising:
an eyewear device comprising:
a frame configured for being worn on a head of a user;
an optical element mounted to the frame, the optical element being positioned on the frame such that the optical element is positioned in a field of view of the user when the frame is worn by the user, the optical element comprising a transparent material;
a heads-up display configured to present text on the optical element;
a processor operatively coupled to the heads-up display;
a transceiver operably coupled to the processor; and
a microphone operably coupled to the processor and mounted to the frame, the microphone being configured to record sung speech from the user;
a speaker remote from the eyewear device;
a remote electronic device remote from the eyewear device, the remote electronic device being communicatively coupled to the eyewear device and the speaker, the remote electronic device having a memory with instructions stored therein, the instructions being executable by the remote electronic device to:
cause the speaker to play a song;
cause the heads-up display of the eyewear device to present lyrics to the song in sync with the speaker playing the song;
cause the microphone of the eyewear device to record audio; and
cause the speaker to play the audio recorded by the microphone as the speaker plays the song.

15. The system of claim 14, wherein the remote electronic device is remote from the speaker.

16. The system of claim 14, further comprising a display screen remote from the eyewear device, the remote electronic device being communicatively coupled to the display screen, the instructions of the remote electronic device further being executable to cause the display screen to present the lyrics to the song in sync with the speaker playing the song.

17. The system of claim 14, wherein the heads-up display is embedded in the optical element.

18. The system of claim 17, wherein the heads-up display is positioned in a lower portion of the optical element.

19. The system of claim 14, wherein:
the frame comprises a pair of temples configured for extending over a pair of ears of the user; and
the optical element is coupled to and extends between the pair of temples.

20. The system of claim 19, wherein the optical element defines a notch on a bottom edge of the optical element for accommodating a nose of the user, the optical element being configured to rest on the nose.
